(19) United States
(12) Patent Application Publication
(10) Pub. No.: US 2005/0044293 A1
(43) Pub. Date: Feb. 24, 2005

(54) Portable memory device that support direct exchange of stored data between two portable memory devices of the same type

(75) Inventor: Fu-Ching Wu, Taipei (TW)

Correspondence Address: Cooper & Dunham LLP, 1185 Avenue of the Americas, New York, NY, 10036, US

(73) Assignee: Luxpro Corporation

(21) Appl. No.: 10/742,371

(22) Filed: Dec. 19, 2003

(30) Foreign Application Priority Data
Aug. 21, 2003 (TW) 092122943

(51) Int. Cl. G06F 3/00

(52) U.S. Cl. 710/52

(57) ABSTRACT

A portable memory device that supports exchange of stored data directly is disclosed. The memory device has an I/O controller embedded with two interface conversion mechanisms, a flash memory unit connected to the I/O controller, a USB interface and an auxiliary I/O interface respectively connected to the I/O controller, and a power unit to supply operating power. Since the I/O controller is powered, the memory device can be connected to another same type memory device through the auxiliary I/O interface for direct exchange of stored data, without need of passing through a host computer or other equivalent electronic device with data exchange capabilities through a USB port. Further, a microprocessor embedded with a format-specific interface conversion mechanism is installed between the auxiliary I/O interface and the flash memory, while the original I/O controller is not altered.

### BACKGROUND OF THE INVENTION

1. Field of the Invention

The present invention is related to a portable memory device that supports exchange of stored data directly, particularly to a portable memory device that supports data exchange with another portable memory device of the same type with no need to connect through a host computer.

2. Description of Related Art

The new generation of data storage devices is designed both for high data storage capacity and simplicity in data exchange. For example, currently available portable memory devices are aimed to replace the conventional floppy disks, which have proven to be too small to meet the data storage requirements for new data formats.

Thanks to the advanced chip fabrication techniques, a reliable I/O controller with a USB interface can now be built into a portable memory device. A USB based plug-in memory pack, having only the size of a cigarette lighter, has become popular among mobile data users and frequent travelers. This plug-in memory pack can hold much more data than a 1.44M floppy disk, and still possesses good capabilities in data exchange and portability.

Equipped with this type of plug-in memory pack, as shown in FIG. 6, a mobile data user can update the data stored in the memory pack through a USB interface of the notebook computer, or simply copy data from one memory pack to the other connected in parallel. Though easy enough to carry around, the USB based plug-in memory pack is a passive type data storage device. The plug-in memory pack needs to be connected to a host computer (60) or other equivalent electronic devices with data exchange capabilities through a USB port, so as to enable data exchange between two flash memory units (50) (51) in different memory packs through the USB port.

Mobile data users can carry the plug-in memory packs around without too much problem, but there is always a possibility that the user will find a situation where the data exchange cannot be executed because a computer connection is not available (for example, direct data exchange between two portable memory devices). In order to be able to use the USB flash memory in the memory pack, the user must always carry a notebook computer or other equivalent electronic device with a USB interface for either data exchange or data storage function, thus making it somewhat less convenient to use.

### SUMMARY OF THE INVENTION

The main object of the present invention is to provide a portable memory device that supports direct data exchange with another portable memory device of the same type, with no need to connect through a host computer or other equivalent electronic device with data exchange capabilities through a USB port.

To this end, the portable memory pack of the present invention includes an I/O controller embedded with a USB interface conversion mechanism and another specific interface conversion mechanism, a flash memory unit connected to an I/O controller, a USB interface and an auxiliary I/O interface respectively connected to the I/O controller, and a power unit that provides operating power for the above mentioned components. Since the I/O controller is connected to the auxiliary I/O interface, the portable memory device can be connected through the auxiliary I/O interface to another portable memory device that also has the same type of auxiliary I/O interface for direct data exchange.

The above I/O controller not only has the basic USB interface conversion capability, but also has a second interface conversion mechanism that supports data exchange through the auxiliary I/O interface.

The portable memory device also has a power unit, so that data exchange can be executed directly between two flash memory units, with no need of passing through the host computer or other equivalent electronic device having data exchange capabilities through a USB port.

The second object of the present invention is to provide a portable memory device that has a microprocessor installed between the flash memory unit and the auxiliary I/O interface, whereby the original settings for the memory device in the I/O controller will remain unaltered after the addition of the microprocessor, and the microprocessor is embedded with a format-specific interface conversion mechanism that can support data exchange through the auxiliary I/O interface. When two memory devices are interconnected for direct data exchange, the microprocessor executes data send and receive through the auxiliary I/O interface after the necessary interface conversion.

In the above mentioned circumstances, the present invention can be implemented with no alteration on the existing I/O controller of a passive type memory device, but data exchange between two memory devices can be executed directly with no need of connecting through a host computer or equivalent electronic device.

Other objectives, advantages and novel features of the invention will become more apparent from the following detailed description when taken in conjunction with the accompanying drawings.

### BRIEF DESCRIPTION OF THE DRAWINGS

FIG. 1 is a system block diagram of a first preferred embodiment of the invention;

FIG. 2 is a pin-to-pin connection chart showing the connections between two portable memory devices through the auxiliary I/O interface;

FIG. 3 is a clock diagram showing the sequence of logic operation for clock output, data strobe, data stream, and control lines when data exchange is executed through the auxiliary I/O interface;

FIG. 4 is system block diagram of a second preferred embodiment of the invention;

FIG. 5 is a perspective view of the direct connection between two portable memory devices through the auxiliary I/O interface; and

FIG. 6 is diagram showing two conventional memory packs connected through the USB ports of the host computer for data exchange.

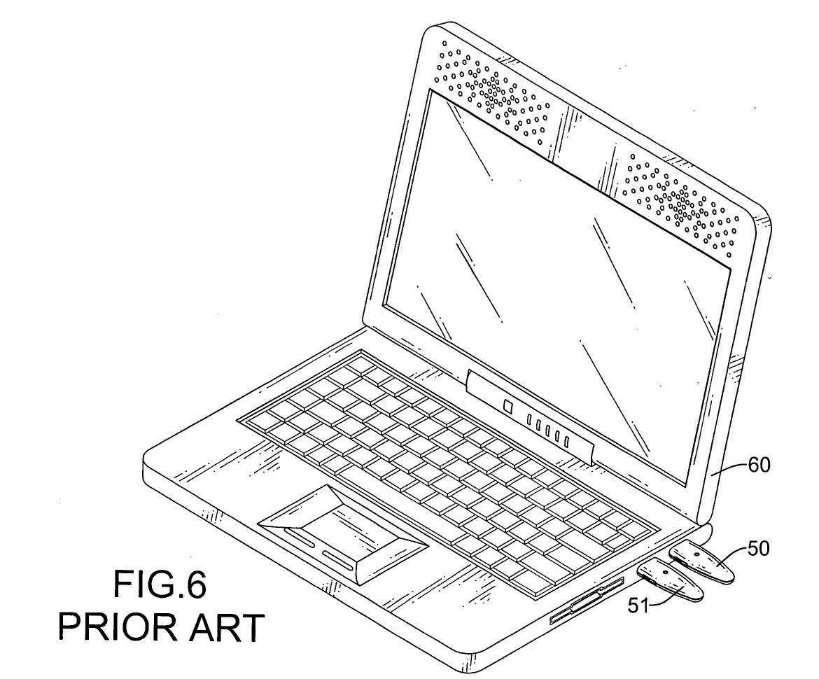

### DETAILED DESCRIPTION OF THE PREFERRED EMBODIMENT

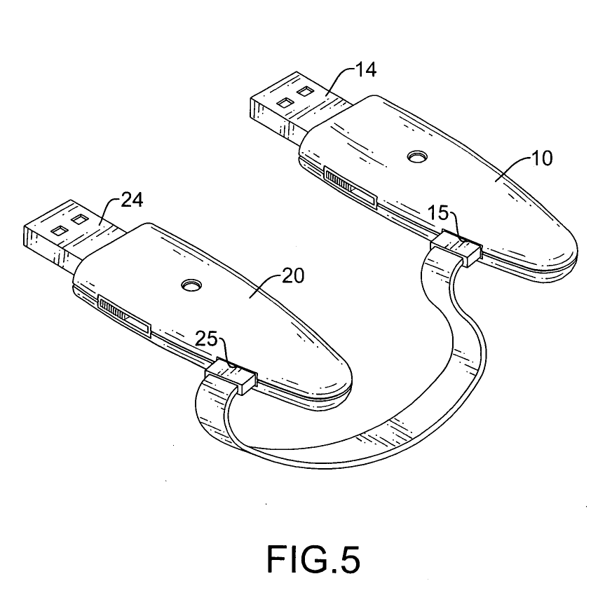

A portable memory device (10) is provided, as shown in FIG. 5, that supports direct data exchange through a format-specific interface conversion mechanism, with no need to connect through a host computer or other equivalent electronic device with data exchange capabilities through a USB port.

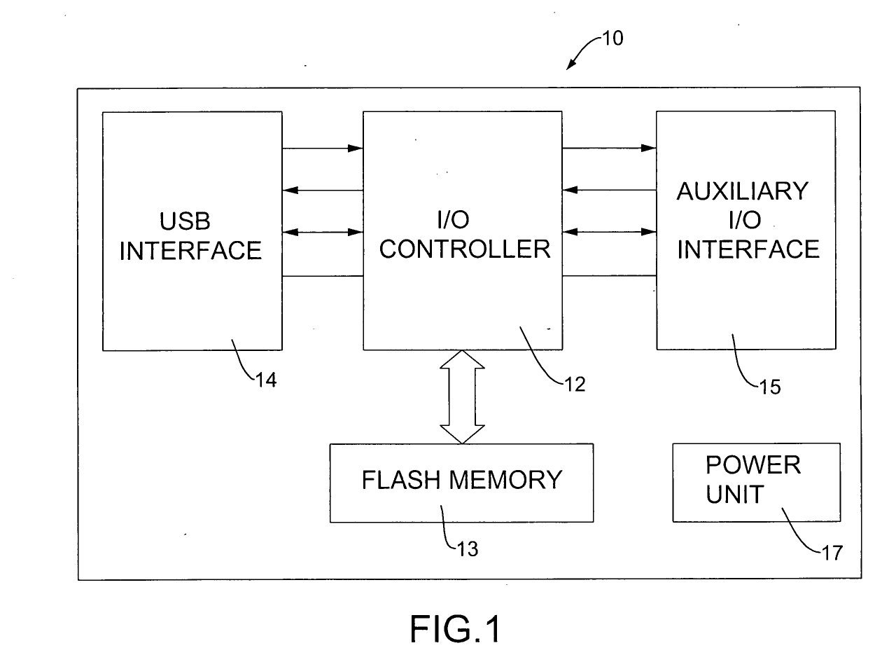

The portable memory device (10) as shown in FIG. 1 comprises:
an I/O controller (12) being embedded with a USB interface conversion mechanism and a format-specific interface conversion mechanism;
a flash memory unit (13) being connected to the I/O controller (12);
a USB interface (14) being connected to the I/O controller (12), which is used for making connection to another device with a USB interface (not shown in diagram);
an auxiliary I/O interface (15) being connected with the I/O controller (12), provided for connection to another memory device having the same I/O specifications, wherein the auxiliary I/O interface (15) is formed by a clock output (Clock), a data port (data), a ground terminal (GND) and two output control lines (Regin/Regout); and
at least one power unit (17) for providing the necessary operating power of the above components.

According to the present invention, there can be more than one input and output terminals on the data port (data) of the auxiliary I/O interface (15), depending on the interface format actually used in the data exchange.

According to the present invention, the auxiliary I/O interface (15) can be implemented with IIC, SPI or GPIO, where the IIC and SPI are serial data transmission interfaces, and GPIO is a parallel data transmission interface, whereby data exchange can be executed between two flash memory units (13) having the same interface by the instructions from the I/O controller (12).

The I/O controller (12) of the portable memory device (10) includes a USB interface conversion mechanism and a format-specific interface conversion mechanism, working in conjunction with the above power unit (17), whereby the I/O controller (12) is able to change the data passed from the flash memory unit (13) to comply with a specific data I/O format (such as USB, IIC, SPI).

If the above portable memory device (10) is connected to another memory device through the USB interface, the I/O controller (12) will use the external instruction sets to execute data read/write in the flash memory unit (13), and all data exchange will be executed through the existing USB interface; whereas, if the portable memory device (10) is connected to a second portable memory device through the auxiliary I/O interface (15) of the same type, the I/O controller (12) will take over the I/O operation and enable the auxiliary interface conversion mechanism to execute data read/write in the flash memory (13) through the auxiliary I/O interface (15).

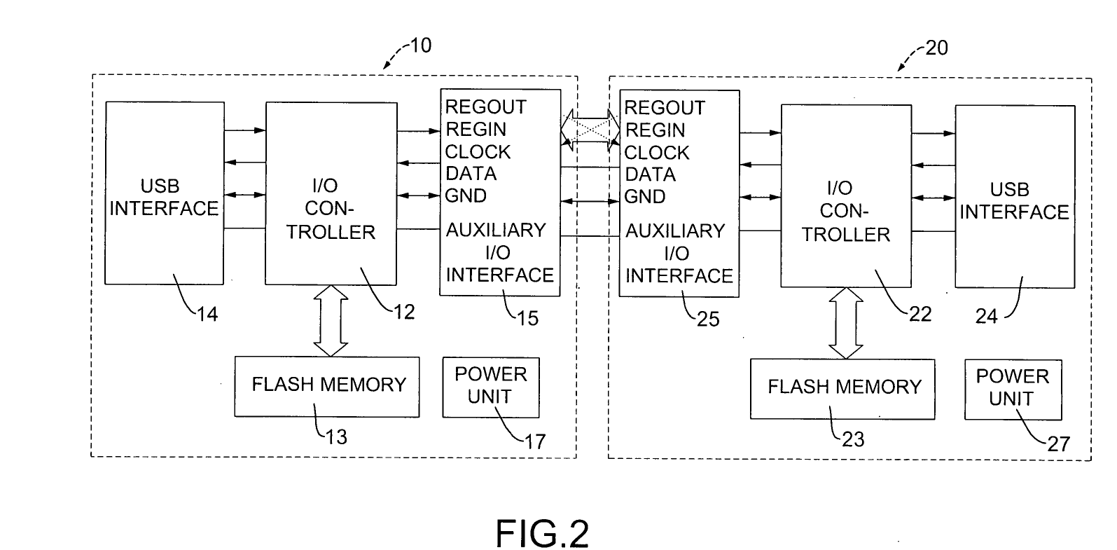

The detailed pin connections for executing the data exchange between two portable memory devices (10) (20) through the respective auxiliary I/O interfaces (15) (25) are shown in FIGS. 2 and 5. Since the two auxiliary I/O interfaces (15) (25) are engaged in direct exchange of stored data, output control line (Regout) of the first auxiliary I/O interface (15) is connected to the input control line (Regin) of the second auxiliary I/O interface (25), and the input control line (Regin) of the first auxiliary I/O interface (15) is connected to the output control line (Regout) of the second auxiliary I/O interface, and the clock output (Clock), data port (data) and the ground terminal (GND) are respectively connected with their counterparts on the opposite memory pack.

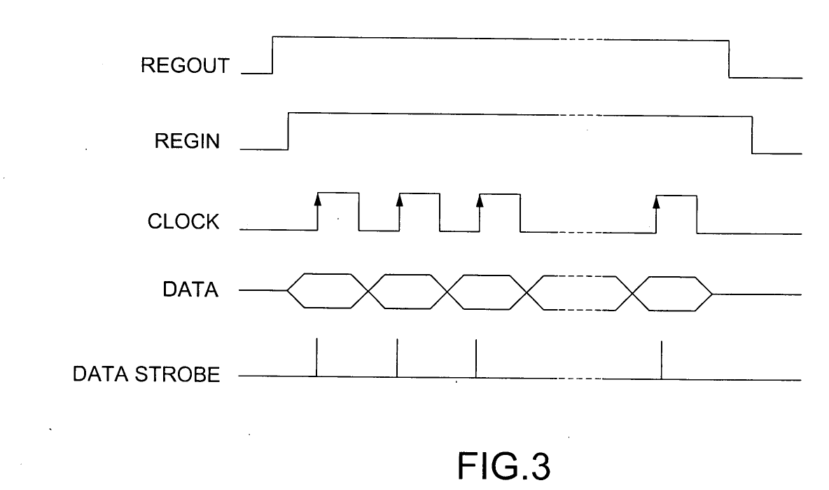

The sequence of logic operation required for data read/write in the first portable memory device (10) is shown in FIG. 3. When the first portable memory device (10) intends to extract data from the second portable memory device (20), the I/O controller (12) of the first portable memory device (10) will output a high voltage pulse through the output control line (Regout) of the first auxiliary I/O interface (15), and the I/O controller (22) of the second portable memory device (20) will receive the high voltage pulse through the input control line (Regin). The I/O controller (22) of the second portable memory device (20) will respond with a high voltage pulse through output control line (Regout), to notify the I/O controller (12) of the first memory device (10) that it is ready for data output. After a short period the I/O controller (12) of the first portable memory device (10) receives the high voltage pulse through the input control line (Regin) of the auxiliary I/O interface (15) and prepares for data reception and conversion and then forwards them to the flash memory unit (13).

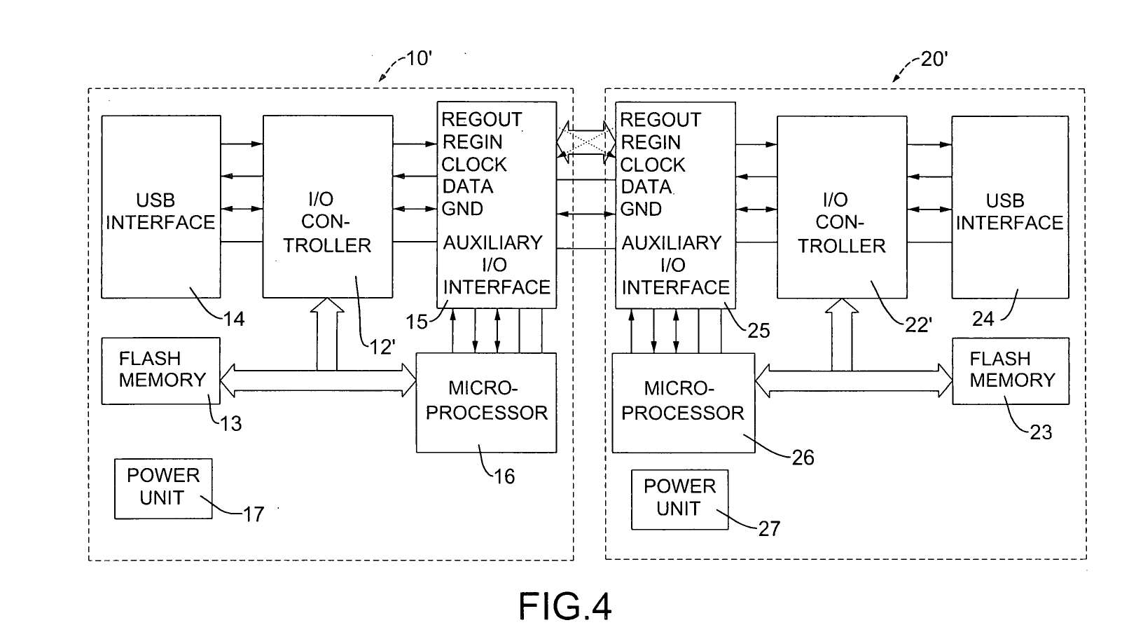

A slightly different control circuit is employed in the second embodiment of the invention as shown in FIG. 4, in which the portable memory device (10′) has a microprocessor (16) installed between the auxiliary I/O interface (15) and a flash memory unit (13), while rest of the components remain the same as in the first embodiment. The second embodiment of the invention is unique in that the microprocessor (16) is embedded with a format-specific interface conversion mechanism, while the I/O controller (12) has only a general purpose USB interface conversion mechanism using the original parameter values of the memory device (10). This means that the I/O controller (12) only handles the USB interface conversion, while the microprocessor (16) handles the format-specific interface conversion for the auxiliary I/O interface (15). Therefore the input/output of the microprocessor (16) is connected to the auxiliary I/O interface (15) for direct data exchange between two portable memory devices. The precondition is that the first portable memory device (10, or 10′) and the second portable memory device (20 or 20′) to be engaged in the direct data exchange have to be of the same type, that is the matching pairs shall be either (10, 20) or (10′, 20′).

From the foregoing, it becomes apparent that the present invention has two slightly different implementations. In the first scheme, the memory pack is provided with an auxiliary I/O interface and an I/O controller which is embedded with a USB interface conversion mechanism and a format-specific interface conversion mechanism, and, in the second case, the memory pack is provided with an auxiliary I/O interface, an original I/O controller, and a microprocessor, which is installed between the flash memory and the auxiliary I/O interface to handle the auxiliary interface conversion, whereby the memory pack is able to conduct direct data exchange with another memory pack of the same type through the auxiliary I/O interface, with no need of passing data through a host computer or other equivalent electronic device with data exchange capabilities through a USB port.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A portable memory device (10) that supports direct exchange of stored data, comprising:
an I/O controller (12) being embedded with a USB interface conversion mechanism and a format-specific interface conversion mechanism;
a flash memory unit (13) being connected to the I/O controller (12) for temporarily saving the transfer data;
a USB interface (14) being connected to the I/O controller (12), which is used for making connection to an external device with a USB port;
an auxiliary I/O interface (15) being connected to the I/O controller (12), provided for connection to another portable memory device of the same type; and
at least one power unit (17), for supplying power to the above components.

2. The portable memory device (10) as claimed in claim 1, wherein the auxiliary I/O interface (15) is formed by a clock output, a data port, a ground terminal and input/output control lines.

3. The portable memory device (10) as claimed in claim 2, wherein the auxiliary I/O interface (15) is an IIC serial data transmission standard.

4. The portable memory device (10) as claimed in 2, wherein the auxiliary I/O interface (15) is an SPI serial data transmission standard.

5. The portable memory device (10) as claimed in 2, wherein the auxiliary I/O interface (15) is a GPIO parallel data transmission standard.

6. A portable memory device (10′) that supports exchange of stored data directly, comprising:
an I/O controller (12) being embedded with a USB interface conversion mechanism;
a microprocessor (16) being embedded with a format-specific interface conversion mechanism;
a flash memory unit (13) being connected between the I/O controller and the microprocessor, for saving the transfer data temporarily;
a USB interface (14) being connected to the I/O controller, which is provided for making connection to an external device with a USB port;
an auxiliary I/O interface (15) being connected to the I/O controller, which is provided for connection to another portable memory device of the same type; and
at least one power unit (17) being used for supplying power to the above components.

7. The portable memory device (10′) as claimed in claim 6, wherein the auxiliary I/O interface (15) is formed by a clock output, a data port, a ground terminal and input/output control lines.

8. The portable memory device (10′) as claimed in claim 7, wherein the auxiliary I/O interface (15) is an IIC serial data transmission specification.

9. The portable memory device (10′) as claimed in claim 7, wherein the auxiliary I/O interface (15) is an SPI serial data transmission specification.

10. The portable memory device (10′) as claimed in 7, wherein the auxiliary I/O interface (15) is a GPIO parallel data transmission standard.
